(19) United States
(12) Patent Application Publication
(10) Pub. No.: US 2014/0359340 A1
(43) Pub. Date: Dec. 4, 2014

(54) SUBSCRIPTIONS THAT INDICATE THE PRESENCE OF APPLICATION SERVERS

(71) Applicant: Alcatel-Lucent USA Inc., Murray Hill, NJ (US)

(72) Inventors: Suzann Hua, Lisle, IL (US); Ahmed N. Zaki, Lisle, IL (US)

(73) Assignee: Alcatel-Lucent USA Inc., Murray Hill, NJ (US)

(21) Appl. No.: 13/905,595

(22) Filed: May 30, 2013

(51) Int. Cl. G06F 11/20

(52) U.S. Cl. CPC G06F 11/2023
USPC 714/4.11

(57) ABSTRACT

Systems and methods for indicating the presence of application servers. The system comprises a serving network element of an IP Multimedia Subsystem (IMS) network configured to communicate with a primary application server to provide a service for a session, to determine that the primary application server is unavailable, to failover to a secondary application server to provide the service, and to initiate a subscribe request to a presence server requesting to be notified when the primary application server becomes available. The serving network element is further configured to receive a notification from the presence server that the primary application server has become available, and to switch back to the primary application server to provide the service after receiving the notification.

### FIELD OF THE INVENTION

The invention relates to the field of telecommunication networks.

### BACKGROUND

Telecommunication networks use application servers of Internet Protocol Multimedia Subsystem Networks (IMS Networks) to provide various voice and data services to users. The CSCFs in IMS networks coordinate the provision of services during sessions between the UE. Examples of voice services are call forwarding, call waiting, etc. Examples of data services are streaming audio, streaming video, Voice over Internet Protocol (VoIP), online gaming, IP-TV, etc.

In order to ensure that available services are reliably provided to UE during a session, telecommunication networks implement redundant application servers. For example, if a primary application server fails while participating in a session to provide a service, the CSCF switches to the backup application server to provide the service. This ensures an enhanced level of reliability at the telecommunication network.

However, backup application servers are not designed to provide the same level of service as primary application server for a prolonged period. For example, a backup application server may not be capable of handling an extended period of peak traffic for a service during certain times of operation, etc. As such, it is typically beneficial for a CSCF to switch a service for a session back to the primary application server as soon as the primary application server has recovered.

In order to detect when the primary application server becomes available, the CSCF periodically sends a “heartbeat” signal to the primary application server until the primary application server comes back online and responds. After the CSCF receives the response from the primary application server, it switches back to the primary application server to provide the service for the session. However, heartbeat signals generate a great deal of overhead and network traffic, which is undesirable.

### SUMMARY

Embodiments described herein utilize presence servers to report the availability of application servers to network elements. The presence servers can store presence information published by different application servers of an IMS network. If desired, a network element (e.g., an S-CSCF) can subscribe to the presence server requesting to be notified when the status of an application server changes. The presence server can then notify the subscribing network element when the status of the application server has changed. Using a subscription-based system to report the availability of an application server substantially reduces network traffic and overhead when compared to systems that use heartbeat signals.

One embodiment is a system comprising a serving network element of an IP Multimedia Subsystem (IMS) network configured to communicate with a primary application server to provide a service for a session, to determine that the primary application server is unavailable, to failover to a secondary application server to provide the service, and to initiate a subscribe request to a presence server requesting to be notified when the primary application server becomes available. The serving network element is further configured to receive a notification from the presence server that the primary application server has become available, and to switch back to the primary application server to provide the service after receiving the notification.

In a further embodiment, the serving network element is further configured to generate the subscribe request as a Session Initiation Protocol (SIP) SUBSCRIBE request.

In a further embodiment, the serving network element comprises a Serving Call Session Control Function (S-CSCF).

In a further embodiment, the serving network element is further configured to include a Session Initiation Protocol (SIP) address for the application server in the subscribe request.

In a further embodiment, the serving network element is further configured to include a name for the service provided by the primary application server in the subscribe request.

In a further embodiment, the serving network element is further configured to identify a Session Initiation Protocol (SIP) address for the presence server, and to initiate the subscribe request to the identified SIP address.

In a further embodiment, the serving network element is further configured to analyze the notification to identify a Session Initiation Protocol (SIP) address, and to determine that the SIP address belongs to the primary application server.

Another embodiment is a method. The method includes operating a serving network element of an IP Multimedia Subsystem (IMS) network to communicate with a primary application server to provide a service for a session, detecting that the primary application server is unavailable, and failing over to a secondary application server to provide the service. The method also includes initiating a subscribe request from the serving network element to a presence server requesting that the serving network element be notified when the primary application server becomes available, receiving a notification from the presence server at the serving network element indicating that the primary application server has become available, and switching back to the primary application server to provide the service after receiving the notification.

Another embodiment is a presence server configured to communicate with network elements of an IP Multimedia Subsystem (IMS) network. The presence server is configured to receive a subscribe request from a serving network element that serves a session, wherein the subscribe request from the serving network element requests that the serving network element be notified when a primary application server becomes available to provide a service for the session. The presence server is further configured to receive a status message published from the primary application server indicating that the primary application server is available, and to send a notification to the serving network element that the primary application server has become available as a response to the subscribe request.

In a further embodiment, the presence server is further configured to access the status message to identify a Session Initiation Protocol (SIP) address for the application server, and to include the SIP address of the application server when notifying the serving network element.

In a further embodiment, the presence server is further configured to notify the serving network element by initiating a Session Initiation Protocol (SIP) NOTIFY to the serving network element.

In a further embodiment, the presence server is further configured to access the status message to identify a name for a service provided by the application server, and to include the name for the service when notifying the serving network element.

In a further embodiment, the presence server is further configured to access the status message to identify a reason why the application server became unavailable, and to include the reason when notifying the serving network element.

In a further embodiment, the presence server is further configured to identify the unavailable application server based on a Session Initiation Protocol (SIP) address included in the subscribe request.

Other exemplary embodiments (e.g., methods and computer-readable media relating to the foregoing embodiments) may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram of a communication network in an exemplary embodiment.

FIG. 2 is a flowchart illustrating a method for operating a communication network in an exemplary embodiment.

FIG. 3 is a block diagram of a communication network in an exemplary embodiment.

FIG. 4 is a message diagram illustrating exemplary communications among the components of the communication network of FIG. 3.

FIG. 5 illustrates an exemplary SIP status change communication provided by an application server to a presence server.

### DETAILED DESCRIPTION

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

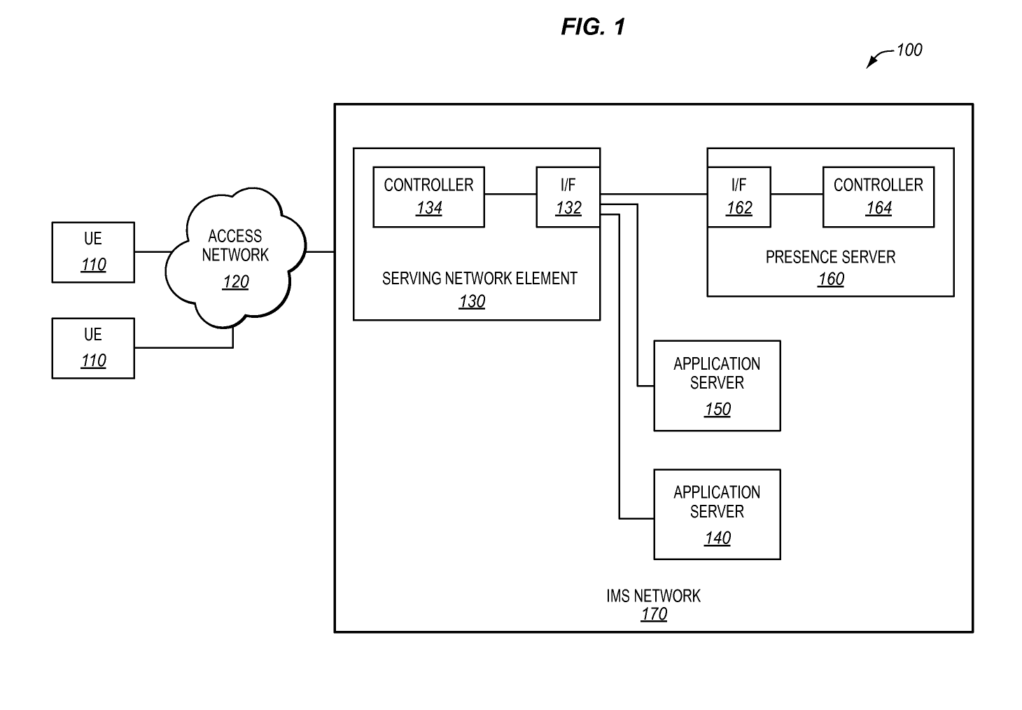

FIG. 1 illustrates a communication network 100 in an exemplary embodiment. Communication network 100 comprises IP Multimedia Subsystem (IMS) network 170. IMS network 170 provides various services for one or more sets of User Equipment (UE) 110 (e.g., mobile phones, tablets, etc.). In this embodiment, IMS network 170 includes serving network element 130, which communicates with application servers 140 and 150 in order to manage services provided to UE 110.

Serving network element 130 comprises any system, component, or device configured to coordinate services for sessions (e.g., sessions between UE 110). For example, serving network element 130 may comprise a Serving-Call Session Control Function (S-CSCF) that processes Session Initiation Protocol (SIP) signaling for a session in order to set up, maintain, and tear down the session. As a part of controlling the services for the session, the S-CSCF can invite application servers to participate in the session in order to provide specific services.

According to FIG. 1, serving network element 130 includes an interface 132, which comprises any suitable combination of circuitry and logic used for communicating with other elements of IMS network 170. Serving network element 130 further includes a controller 134 configured to manage the operations of serving network element 130. Controller 134 can be implemented as custom circuitry, a processor executing programmed instructions stored in program memory, or some combination thereof.

Serving network element 130 contacts UEs 110 through access network 120. Access network 120 comprises any type of network that interfaces UEs 110 with IMS network 170. Examples of access network 120 include a Radio Access Network (RAN), such as a UMTS Terrestrial Radio Access Network (UTRAN), an enhanced UTRAN (E-UTRAN), an Interworking-Wireless Local Area Network (I-WLAN), etc.

Within IMS network 170, application servers 140 and 150 are each capable of providing services for IMS sessions (e.g., between UEs 110). These application servers may operate in an active-active mode, where both servers act in concert to provide a service. In the active-active mode, each server acts as a backup to the other. In such cases, serving network element 130 may use one server as the primary server for one group of UEs 110, and may use the other server as the primary server for another group of UEs 110. The application servers may also be implemented in an active-passive mode, where one primary application server provides the service to all UEs 110, while the other server acts as a dedicated backup.

IMS network 170 further includes a presence server 160. Presence server 160 comprises any suitable system, component, or device configured to report the status of an application server to one or more network elements of a telecommunication network. Specifically, presence server 160 is capable of notifying serving network element 130 when the status of application server 140 changes. In this embodiment, presence server 160 includes an interface 162 configured to communicate with other network elements of IMS network 170, and further includes a controller 164 for managing the operations of presence server 160. Controller 164 can be implemented as custom circuitry, a processor executing programmed instructions stored in program memory, or some combination thereof.

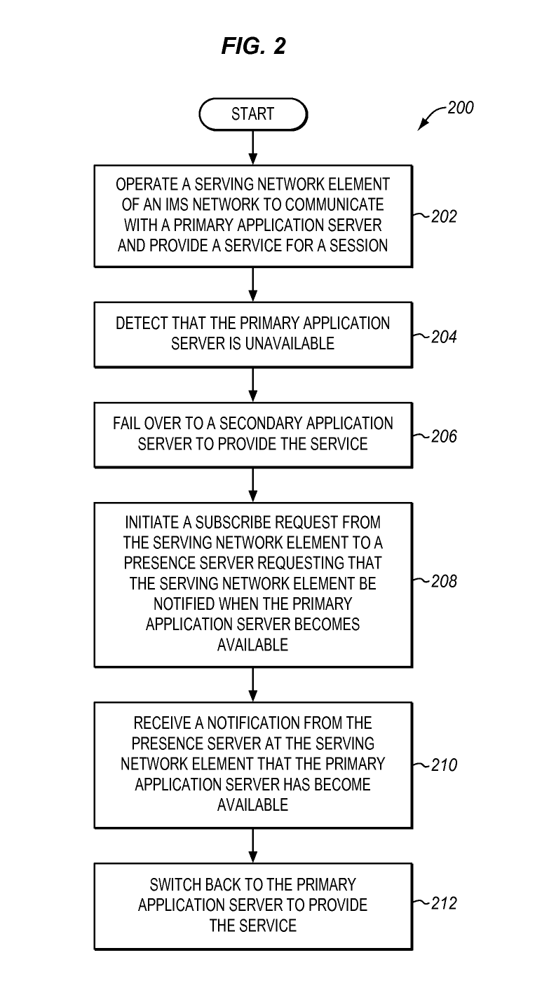

IMS network 170 can further include any suitable combination of additional network elements (shown in FIG. 1). These additional elements have been omitted from FIG. 1 for ease of illustration. Details of the operation of communication network 100 will be discussed with regard to FIG. 2.

FIG. 2 is a flowchart illustrating a method 200 for operating a communication network in an exemplary embodiment. The steps of method 200 are described with reference to communication network 100 of FIG. 1, but those skilled in the art will appreciate that method 200 may be performed in other systems. The steps of the flowcharts described herein are not all inclusive and may include other steps not shown. The steps described herein may also be performed in an alternative order.

In step 202, serving network element 130 communicates with primary application server 140 (via interface 132) to provide a service for a session (e.g., between UEs 110). At some point in time, primary application server 140 becomes unavailable, rendering it unable to provide the service. The unavailable status can result from a planned reboot of application server 140, from an unexpected power failure, or from other factors (such as a software error at application server 140 that results in a reboot, a loss of network connectivity, etc.). Primary application server 140 does not necessarily lose control of every service that it provides when it becomes unavailable. However, the failure does cause primary application server 140 to become unable to provide the service for the current session.

Serving network element 130 detects that primary application server 140 is unavailable in step 204. For example, serving network element 130 may determine that a failure has occurred if primary application server 140 has become unresponsive for a predefined period of time, or has failed to respond to a predefined number of SIP requests.

In response to the failure of application server 140, serving network element 130 switches from primary application server 140 to secondary application server 150 in step 206 in order to provide the service for the session. Although serving network element 130 has switched to secondary application server 150, it is desirable to revert back to primary application server 140 when it becomes available.

Therefore, in order to determine when primary application server 140 becomes available, serving network element 130 generates a subscribe request (e.g., a SIP SUBSCRIBE) and initiates (e.g., transmits) the subscribe request to presence server 160 in step 208. The subscribe request asks that serving network element 130 be notified when primary application server 140 becomes available again (e.g., when application server 140 has returned from a failed state).

Eventually, application server 140 recovers from its unavailable state. This may comprise re-booting application server 140, correcting a memory error at application server 140, etc. After application server 140 becomes available, it can resume its intended role as the primary application server for this service. Therefore, application server 140 transmits a status message (e.g., a SIP PUBLISH) to presence server 160 to indicate that it is available. The status message can include further information such as the reason for the failure, the time at which application server 140 recovered from its failed state, the names of services provided by application server 140, a name/address of application server 140, etc.

Presence server 160 receives and analyzes the status message to determine that application server 140 has recovered and once again become available. Thus, presence server 160 provides a notification (e.g., a SIP NOTIFY) to serving network element 130 (and any other subscribing network elements) indicating that application server 140 has become available.

Serving network element 130 receives the notification in step 210, and switches back to primary application server 140 in order to provide the service for the session. Method 200 is advantageous over prior systems that utilize heartbeat signaling because it eliminates a great deal of network traffic and associated overhead. This in turn enhances overall network performance when a primary application server is down. Since heartbeat signals are not constantly being generated and monitored, the network has more resources available to service communications between network users.

### Examples

In the following examples, additional processes, systems, and methods are described in the context of a communication network that utilizes SIP subscription techniques to coordinate service transfers between application servers.

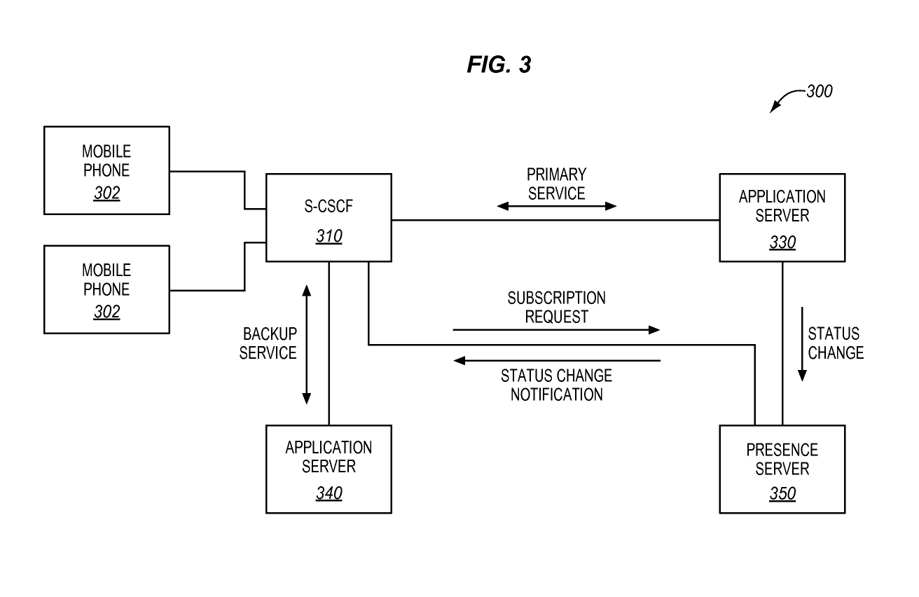

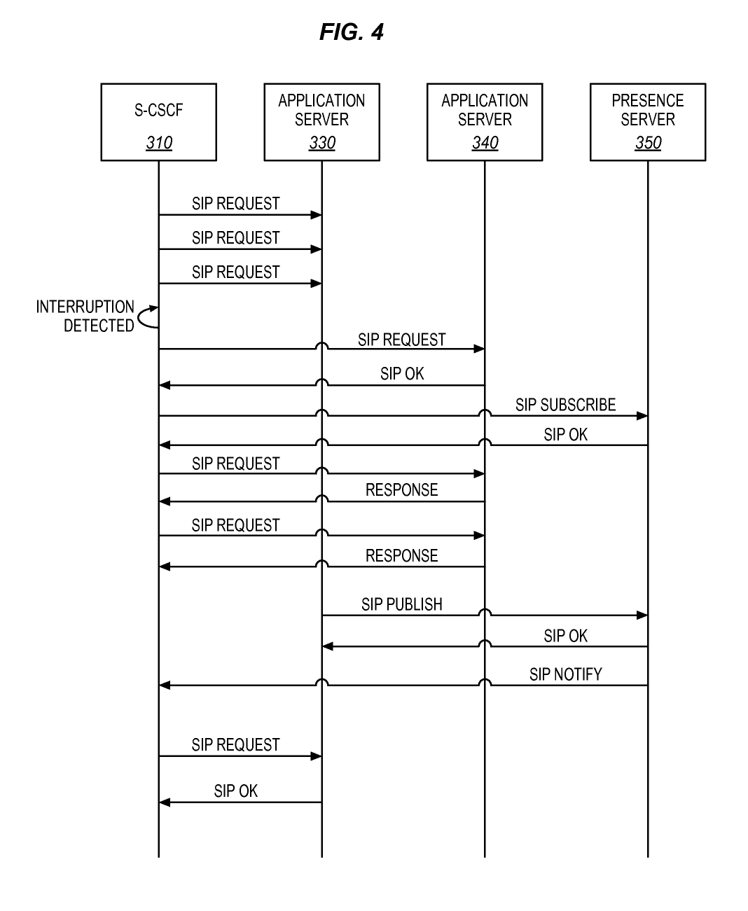

FIG. 3 is a block diagram of a communication network 300 in an exemplary embodiment. According to FIG. 3, Serving CSCF (S-CSCF) 310 operates in the role of a serving network element that coordinates the provisioning of services during sessions between UEs 302. During normal operations for a session between mobile phones 302, S-CSCF 310 exchanges SIP messaging with application server 330 in order to provide a call waiting service to mobile phones 302. However, at some point in time, application server 330 encounters a power failure. This causes application server 330 to become unresponsive, meaning that it can no longer participate in the session. When application server 330 encounters the power failure, S-CSCF 310 contacts application server 340 in order to provide the call waiting service for the session. Therefore, application server 340 functions as a secondary application server. S-CSCF 310 also subscribes to presence server 350 in order to determine when application server 330 recovers from its failure. The specific communications between these various network elements are discussed in detail with regard to FIG. 4.

FIG. 4 is a message diagram illustrating exemplary communications among the components of the communication network of FIG. 3. According to FIG. 4, when application server 330 becomes unavailable during the session, S-CSCF 310 is initially unaware of the failure. Thus, S-CSCF 310 continues to transmit SIP requests to application server 330. After determining that application server 330 has been unresponsive for a period of time, S-CSCF 310 reviews internal memory to identify a SIP address for secondary application server 340. S-CSCF 310 then transmits SIP requests for the service to secondary application server 340, which responds to the SIP requests with SIP 200 OK messages (or any suitable SIP messaging). Having found an adequate backup service, S-CSCF 310 reviews its internal memory to determine the SIP address of presence server 350. S-CSCF 310 transmits a SIP SUBSCRIBE request to presence server 350, and includes presence event filter criteria in the request. The presence event filter criteria indicate that S-CSCF 310 is to be notified when application server 330 returns from its present inactive status. The criteria also specifically name application server 330, provide a SIP address for application server 330, and indicate a name for the service provided by application server 330.

Presence server 350, upon receiving the SIP SUBSCRIBE request, responds with a SIP 200 OK to indicate that S-CSCF 310 has been successfully added as a subscriber. Messaging then continues between S-CSCF 310 and application server 340. After primary application server 330 recovers, it reviews its internal memory to determine the SIP address of presence server 350. A controller at application server 330 then generates a SIP PUBLISH request, which is transmitted to presence server 350. The SIP PUBLISH request includes an address for application server 330, a time at which application server 330 recovered from an error, a reason for the error (“POWER FAILURE”) and a name for the service provided by application server 330.

Presence server 350 identifies application server 330 based on its SIP address in the SIP PUBLISH request, responds to application server 330 with a SIP 200 OK message, and then reviews its memory to determine that S-CSCF 310 is subscribed and waiting for application server 330 to recover. Presence server 350 then generates and transmits a SIP NOTIFY request to inform S-CSCF 310 that the service is again available at application server 330. The SIP NOTIFY includes the SIP address of application server 330, includes a name for the service provided by application server 330, and also includes the reason why application server 330 failed. S-CSCF 310 reviews the NOTIFY and determines, based on the SIP address in the SIP NOTIFY, that applications server 330 has become available. Therefore, S-CSCF 310 switches back to application server 330 by sending SIP requests for the service to application server 330 instead of application server 340.

Thus, to UE 302, the service for the session continues seamlessly, even though application server 330 cycled between available and unavailable states while on the network.

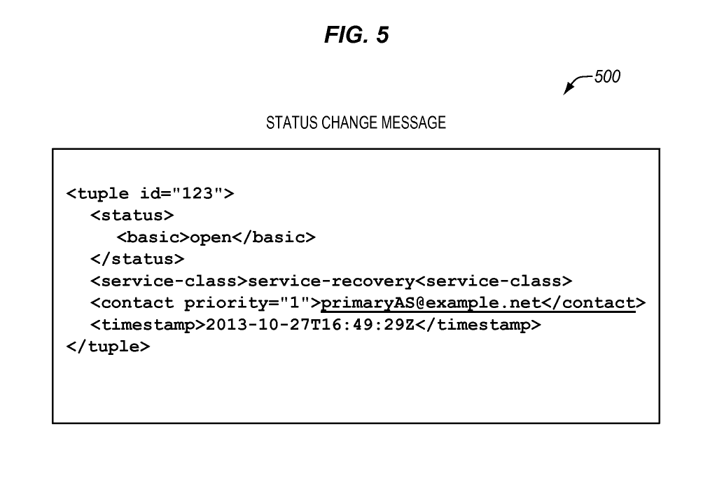

FIG. 5 illustrates an exemplary SIP status change communication 500 (e.g., a SIP NOTIFY) provided by an application server to a presence server. In this example, communication 500 includes a tuple that describes the currents status of application server 330 (“open”), a service class (“service-recovery”) indicating that the service has been restored from an interrupted state, a time stamp, and a contact address for responding to application server 330.

Any of the various elements shown in the figures or described herein may be implemented as hardware, software, firmware, or some combination of these. For example, an element may be implemented as dedicated hardware. Dedicated hardware elements may be referred to as “processors,” “controllers,” or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the invention is not limited to those specific embodiments. The scope of the invention is defined by the following claims and any equivalents thereof

We claim:

1. A system comprising:
a serving network element of an IP Multimedia Subsystem (IMS) network configured to communicate with a primary application server to provide a service for a session, to determine that the primary application server is unavailable, to failover to a secondary application server to provide the service, and to initiate a subscribe request to a presence server requesting to be notified when the primary application server becomes available,
the serving network element further configured to receive a notification from the presence server that the primary application server has become available, and to switch back to the primary application server to provide the service after receiving the notification.

2. The system of claim 1, wherein:
the serving network element is further configured to generate the subscribe request as a Session Initiation Protocol (SIP) SUBSCRIBE request.

3. The system of claim 1, wherein:
the serving network element comprises a Serving Call Session Control Function (S-CSCF).

4. The system of claim 1, wherein:
the serving network element is further configured to include a Session Initiation Protocol (SIP) address for the application server in the subscribe request.

5. The system of claim 1, wherein:
the serving network element is further configured to include a name for the service provided by the primary application server in the subscribe request.

6. The system of claim 1, wherein:
the serving network element is further configured to identify a Session Initiation Protocol (SIP) address for the presence server, and to initiate the subscribe request to the identified SIP address.

7. The system of claim 1, wherein:
the serving network element is further configured to analyze the notification to identify a Session Initiation Protocol (SIP) address, and to determine that the SIP address belongs to the primary application server.

8. A method comprising:
operating a serving network element of an IP Multimedia Subsystem (IMS) network to communicate with a primary application server to provide a service for a session;
detecting that the primary application server is unavailable;
failing over to a secondary application server to provide the service;
initiating a subscribe request from the serving network element to a presence server requesting that the serving network element be notified when the primary application server becomes available;
receiving a notification from the presence server at the serving network element indicating that the primary application server has become available; and
switching back to the primary application server to provide the service after receiving the notification.

9. The method of claim 8, further comprising:
transmitting the subscribe request comprises initiating a Session Initiation Protocol (SIP) SUBSCRIBE request.

10. The method of claim 8, wherein:
the serving network element comprises a Call Session Control Function (CSCF).

11. The method of claim 8, further comprising:
including a Session Initiation Protocol (SIP) address for the application server in the subscribe request.

12. The method of claim 8, further comprising:
including a name for the service provided by the primary application server in the subscribe request.

13. The method of claim 8, further comprising:
identifying a Session Initiation Protocol (SIP) address for the presence server; and
initiating the subscribe request to the identified SIP address.

14. The method of claim 8, further comprising:
analyzing the notification to identify a Session Initiation Protocol (SIP) address; and
determining that the SIP address belongs to the primary application server.

15. A system comprising:
a presence server configured to communicate with network elements of an IP Multimedia Subsystem (IMS) network,
the presence server configured to receive a subscribe request from a serving network element that serves a session, wherein the subscribe request from the serving network element requests that the serving network element be notified when a primary application server becomes available to provide a service for the session,
the presence server further configured to receive a status message published from the primary application server indicating that the primary application server is available, and to send a notification to the serving network element that the primary application server has become available as a response to the subscribe request.

16. The system of claim 15, wherein:
the presence server is further configured to access the status message to identify a Session Initiation Protocol (SIP) address for the application server, and to include the SIP address of the application server when notifying the serving network element.

17. The system of claim 15, wherein:
the presence server is further configured to notify the serving network element by initiating a Session Initiation Protocol (SIP) NOTIFY to the serving network element.

18. The system of claim 15, wherein:
the presence server is further configured to access the status message to identify a name for a service provided by the application server, and to include the name for the service when notifying the serving network element.

19. The system of claim 15, wherein:
the presence server is further configured to access the status message to identify a reason why the application server became unavailable, and to include the reason when notifying the serving network element.

20. The system of claim 15, wherein:
the presence server is further configured to identify the unavailable application server based on a Session Initiation Protocol (SIP) address included in the subscribe request.
